(19) United States
(12) Patent Application Publication
(10) Pub. No.: US 2025/0036155 A1
(43) Pub. Date: Jan. 30, 2025

(54) PEDAL SIMULATOR

(71) Applicant: HL MANDO CORPORATION, Gyeonggi-do (KR)

(72) Inventors: Soo Yong JEON, Gyeonggi-do (KR); Hyun Dong KIM, Gyeonggi-do (KR); Jiyun PARK, Gyeonggi-do (KR)

(21) Appl. No.: 18/694,919

(22) PCT Filed: Sep. 29, 2022
(86) PCT No.: PCT/KR2022/014671

§ 371 Date: Mar. 22, 2024

(30) Foreign Application Priority Data
Sep. 29, 2021 (KR) 10-2021-0129207
Sep. 29, 2021 (KR) 10-2021-0129283
Sep. 29, 2021 (KR) 10-2021-0129284
Sep. 28, 2022 (KR) 10-2022-0123832

(51) Int. Cl. G05G 5/03

(52) U.S. Cl. CPC G05G 5/03

(57) ABSTRACT

A pedal simulator including a cylinder body featuring an open side and a closed side, a piston for pedal operation, a guide bushing to reduce friction, a damper for pedal feel transfer to an electric booster, a push rod connecting the pedal and piston, and a return means for restoring the push rod's position after moving forward.

### TECHNICAL FIELD

The present disclosure relates to a pedal simulator, and more particularly, to a pedal simulator configured to transmit a pedal operation of a driver to an electric control system and provide a reaction force to the driver.

### BACKGROUND ART

A vehicle is essentially equipped with a brake system for braking the vehicle. Various types of brake systems have been proposed to provide safety for a driver and a passenger.

The brake system in the related art mainly operates in such a way that when the driver pushes a brake pedal, a booster mechanically connected to the brake pedal is used to supply a wheel cylinder with a liquid pressure required to brake the vehicle.

However, as there is an increasing demand from the market to implement various braking functions in order to appropriately cope with operational environments of vehicles, electronic brake systems have recently widely proliferated, in which when a driver pushes a brake pedal, a pedal displacement sensor, which detects a displacement of the pedal, transmits an electrical signal to indicate a driver's intention to brake, and a liquid pressure supply device operates in response to the electrical signal to supply a wheel cylinder with a liquid pressure required to brake the vehicle.

The electronic brake system is equipped with a simulator provided in an electric booster and configured to create braking performance. The simulator creates the braking performance by using a pressure generated as a force, which is transmitted when the driver pushes the brake pedal, operates a master cylinder.

However, because the simulator in the related art is provided in the electric booster as described above, a shape of the electric booster needs to be inevitably changed when the braking performance is intended to be changed. However, a large volume of the electric booster causes a limitation in configuring an engine room, and a heavy weight of the electric booster requires that a firewall in the vehicle has high rigidity. As described above, there are many limitations in changing the braking performance of the simulator.

### DISCLOSURE

### Technical Problem

An object of the present disclosure is to provide a pedal simulator that is separated from an electric control system, which may improve a degree of installation freedom and prevent the occurrence of impact and noise, the pedal simulator being capable of transmitting a pedal operation of a driver to the electric control system and providing a reaction force to the driver.

### Technical Solution

An embodiment of the present disclosure provides a pedal simulator including: a cylinder body having a groove so that one side thereof is opened, and the other side thereof is closed; a piston inserted in one side of the cylinder body and configured to be movable forward and rearward in conjunction with an operation of a pedal; a guide bushing provided at one side of the cylinder body and configured to reduce friction between the cylinder body and the piston; a damper provided in the cylinder body and configured to transfer pedal feel to an electric booster by means of a pressure applied from the piston; a push rod having one side connected to the pedal, and the other side connected to the piston, the push rod being configured to move the piston forward toward the damper in conjunction with the operation of the pedal; and a return means provided while covering one side of the guide bushing and a part of the push rod and configured to provide a restoring force for moving rearward the push rod that has moved forward.

In addition, the cylinder body may include a damper coupling portion protruding from a position spaced apart from the other side of the cylinder body by a preset distance toward one side of the cylinder body, the damper coupling portion being formed so that the damper is coupled to the damper coupling portion.

In addition, the damper coupling portion may include a damper coupling groove formed concavely in one surface thereof so that the damper is inserted and coupled into the damper coupling groove.

In addition, the damper coupling portion may further include one or more vent holes formed through the damper coupling portion in a direction parallel to a longitudinal direction of the cylinder body so that air in the cylinder body is discharged to the outside or outside air is introduced into the cylinder body.

In addition, the cylinder body may further include blade portions extending from an outer peripheral surface of the cylinder body in a direction intersecting a longitudinal direction of the cylinder body, and the blade portions may be provided as a pair of blade portions formed to be symmetric based on a central axis that penetrates the cylinder body in the longitudinal direction of the cylinder body.

In addition, a through-hole may be formed in the blade portion in a direction parallel to the longitudinal direction of the cylinder body.

In addition, the pedal simulator may further include: a fastening member configured to penetrate the through-hole and coupled to the cylinder body, the fastening member being configured to fix the cylinder body to a vehicle.

In addition, the guide bushing may include a bushing body having a hollow portion formed in a longitudinal direction so that the piston is penetratively inserted in the hollow portion.

In addition, the guide bushing may include a lubricant flow path formed concavely in an inner peripheral surface of the bushing body by a preset length in a longitudinal direction of the bushing body from a position spaced apart from the other side of the bushing body by a preset distance toward one side of the bushing body so that the lubricant flow path stores a lubricant.

In addition, the lubricant flow path may be provided as a plurality of lubricant flow paths spaced apart from one another by a preset angle in a circumferential direction of the bushing body.

In addition, the guide bushing may further include a bushing flange protruding from an outer peripheral surface of the bushing body at a position spaced apart from one side of the bushing body by a preset distance toward the other side of the bushing body, the bushing flange extending in a circumferential direction of the bushing body.

In addition, the return means may include: a first elastic member connected to one side of the guide bushing while covering the push rod and configured to move the push rod rearward by an elastic force; and a boot coupled to one side of the guide bushing while covering the first elastic member and configured to be contracted and expanded by the forward and rearward movements of the piston.

In addition, the return means may further include a second elastic member configured to cover the damper and having one side connected to the damper coupling portion, and the other side connected to the piston, the second elastic member being provided in the cylinder body and configured to move the piston rearward by an elastic force.

In addition, the guide bushing may further include a vent flow path provided to allow air to flow in accordance with a change in volume of an interior of the cylinder body and a change in volume of the boot by the forward and rearward movements of the piston.

In addition, the vent flow path may be formed concavely in an inner peripheral surface of the bushing body in a longitudinal direction, and the vent flow path may be provided as a plurality of vent flow paths spaced apart from one another by a preset angle in a circumferential direction of the bushing body.

In addition, the vent flow path may be formed between the adjacent lubricant flow paths.

In addition, the pedal simulator may further include: a filter member provided at the other side of the cylinder body and configured to remove foreign substances in air introduced into the cylinder body from the outside.

In addition, the filter member may include: a filter disposed forward of the damper coupling portion; and a filter fixing cover coupled to the cylinder body and disposed at a position opposite to the damper coupling portion to prevent the filter from being withdrawn.

In addition, the piston may include a piston flange protruding from an outer peripheral surface at a position spaced apart from the other side by a preset distance toward one side, the piston flange extending in a circumferential direction of the piston.

In addition, the pedal simulator may further include: a stopper member provided between the piston flange and the guide bushing and configured to absorb an impact and prevent noise when the impact and noise are generated by the forward and rearward movements of the piston.

Other detailed matters of the exemplary embodiment are included in the detailed description and the drawings.

### Advantageous Effects

The pedal simulator according to the present disclosure may have the following effects.

First, the pedal simulator separated from the electric control system (electric booster) may be implemented, thereby improving a degree of installation freedom in the engine room.

Second, because the pedal simulator is separated from the electric control system (electric booster), such that the sizes, which may correspond to various braking performances, are freely deformed.

Third, the guide bushing may be provided between the piston and the cylinder body, thereby preventing noise from occurring because of friction when the piston moves forward and rearward.

Fourth, the ventilation means may be provided, thereby preventing noise from being generated by a flow of air when the pedal simulator operates.

Fifth, the stopper member may be provided, thereby absorbing an impact and preventing noise when the impact and noise are generated when the pedal simulator operates.

### DESCRIPTION OF DRAWINGS

FIG. 1 is an exploded perspective view of a pedal simulator according to an embodiment of the present disclosure.

FIG. 2 is a cross-sectional view of the pedal simulator according to the embodiment of the present disclosure.

FIG. 3 is a partially enlarged perspective view illustrating a state in which a blade portion of a cylinder body and a fastening member are coupled.

FIG. 4 is a perspective view illustrating the fastening member.

FIG. 5 is a partially enlarged cross-sectional view of part ‘A’ in FIG. 2.

FIG. 6 is a perspective view and a partial cross-sectional view of a guide bushing.

FIG. 7 is a perspective view illustrating a stopper member.

FIG. 8 is a partially enlarged perspective view illustrating a part of the cylinder body and a filter member.

### MODE FOR INVENTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics.

Embodiments of the present disclosure illustrate ideal embodiments of the present disclosure in detail. As a result, various modifications of the drawings are expected. Therefore, the embodiments are not limited to specific forms in regions illustrated in the drawings, and for example, include modifications of forms by the manufacture thereof.

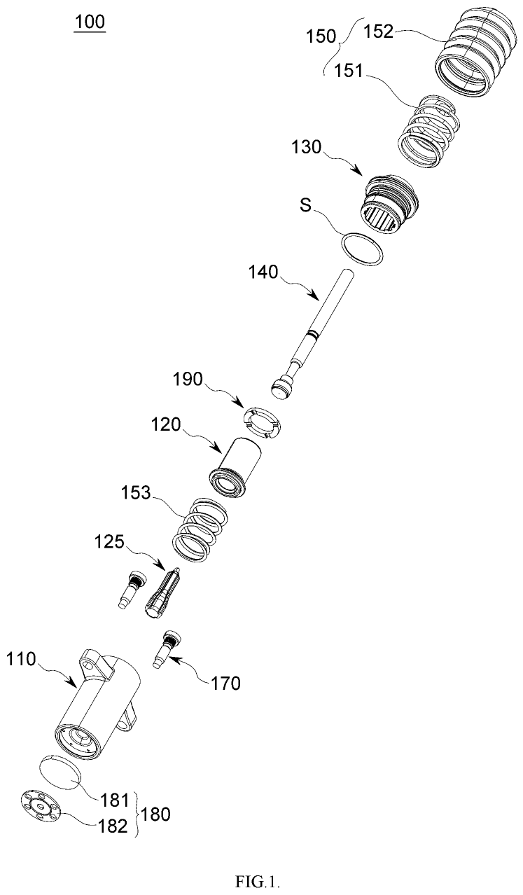

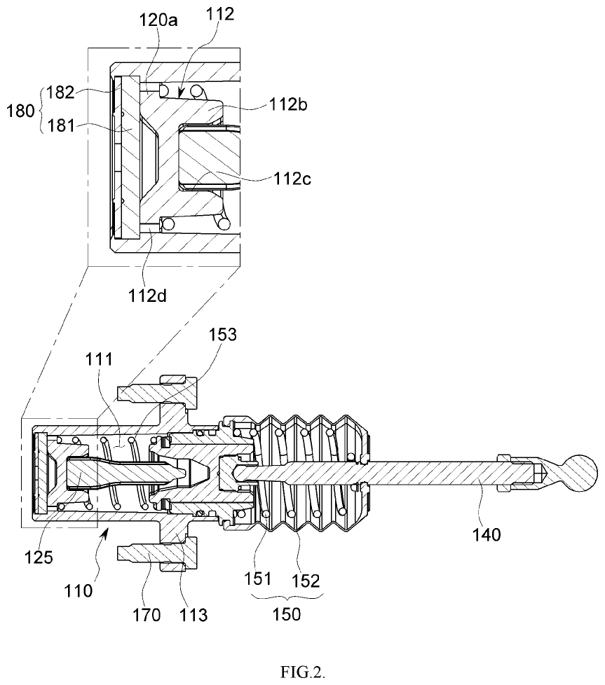

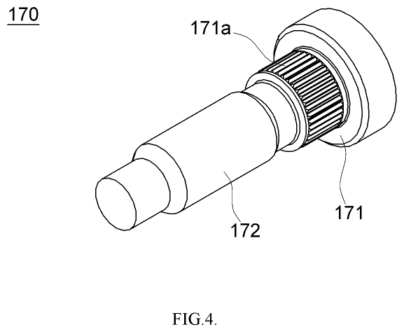

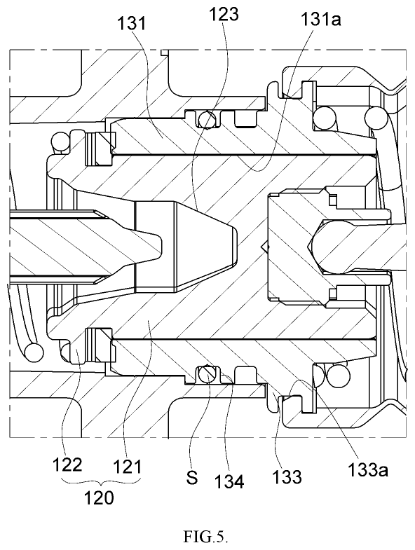

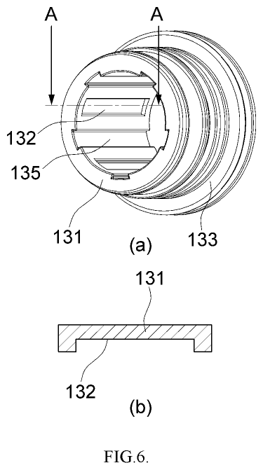

Hereinafter, a pedal simulator according to the present disclosure will be described in detail with reference to FIGS. 1 to 8.

A pedal simulator 100 according to an embodiment of the present disclosure includes a cylinder body 110, a piston 120, a guide bushing 130, a damper 125, a push rod 140, a return means 150, fastening members, and a filter member 180.

The cylinder body 110 has a groove 111 therein so that one side of the cylinder body 110 is opened and the other side of the cylinder body 110 is closed. The cylinder body 110 includes a damper coupling portion 112 to which the damper 125 is coupled so that the damper 125 may be provided in the cylinder body 110.

The damper coupling portion 112 protrudes toward one side of the cylinder body 110 from a position spaced apart from the other side of the cylinder body 110 by a preset distance toward one side of the cylinder body 110. The damper coupling portion 112 includes a first protruding portion 112a protruding from the other side toward one side of the cylinder body 110, a second protruding portion 112b protruding from the first protruding portion 112 toward one side of the cylinder body 110.

A size of a cross-section of the second protruding portion 112b, which intersects a longitudinal direction, is smaller than a size of a cross-section of the first protruding portion 112a that intersects the longitudinal direction. A damper coupling groove 112c is formed in one surface of the second protruding portion 112b and formed to be concave toward the first protruding portion 112a so that the damper 125 may be coupled to the damper coupling groove 112c.

Vent holes 112d are formed in the damper coupling portion 112 so that air in the cylinder body 110 is discharged to the outside or outside air is introduced into the cylinder body 110. Specifically, the vent hole 112d is formed through the first protruding portion 112a in a direction parallel to the longitudinal direction of the cylinder body 110. The vent holes 112d are provided as a plurality of vent holes 112d spaced apart from one another by a preset angle in a circumferential direction of the first protruding portion 112a.

The cylinder body 110 includes blade portions 113. The blade portions 113 are formed to mount the pedal simulator 100 in a vehicle. The blade portions 113 protrude from an outer peripheral surface of the cylinder body 110. The blade portions 113 extend in a direction intersecting the longitudinal direction of the cylinder body 110. The blade portions 113 are formed as a pair of blade portions 113 formed to be symmetric with respect to a central axis parallel to the longitudinal direction of the cylinder body 110.

The blade portion 113 may be formed in a plate shape having a preset thickness. However, the shape of the blade portion 113 is not limited, and the blade portion 113 may be formed in various shapes. The blade portion 113 has a through-hole 113a formed through the blade portion 113 in a thickness direction parallel to the longitudinal direction of the cylinder body 110. Fastening members 170 are coupled to the through-holes 113a.

The pedal simulator 100 is installed in a vehicle (not illustrated) by the fastening members 170. As described above, the fastening members 170 are penetratively inserted into the through-hole 113a formed in the blade portion 113. When the pedal simulator 100 is intended to be installed in the vehicle (not illustrated), the cylinder body 110 is fixed to the vehicle (not illustrated) and the pedal simulator 100 is installed in the vehicle (not illustrated) only by inserting the fastening member 170 into the vehicle (not illustrated).

Meanwhile, the cylinder body 110 is manufactured by insert-injection molding in a state in which the cylinder body 110 includes the fastening members 170.

In the present embodiment, the cylinder body 110 is made of a plastic material. In the related art, a cylinder body is made of a metallic material such as aluminum or steel, and a fastening member is coupled to the cylinder body by press-fitting. However, in the present embodiment, as described above, the cylinder body is made of a plastic material, such that there is a risk in that the blade portion 113 is damaged during the process of press-fitting the fastening member 170. Therefore, the cylinder body 110 is manufactured by insert-injection molding in the state in which the cylinder body 110 includes the fastening members 170, thereby ensuring the quality and durability of the cylinder body 110.

The fastening member 170 includes a head portion 171 and an insertion fixing portion 172. The head portion 171 is a portion inserted into the through-hole 113a of the blade portion 113. Protrusions 171a are formed on an outer peripheral surface of the head portion 171. The protrusions 171a are continuously formed in a circumferential direction of the head portion 171. The protrusions 171a reduce a contact area between the fastening member 170 and the blade portion 113.

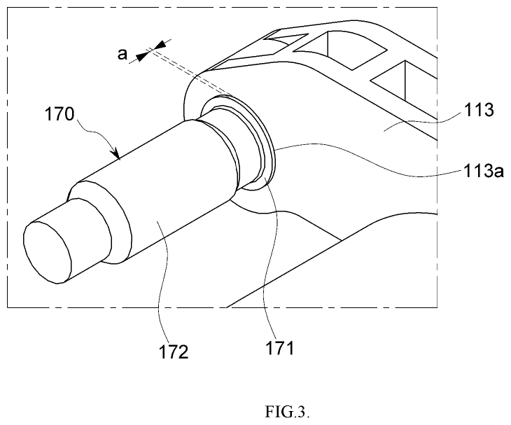

The insertion fixing portion 172 extends from one surface of the head portion 171. The insertion fixing portion 172 is a portion to be inserted into the vehicle (not illustrated), and the cylinder body 110 is fixed by the insertion fixing portion 172. Meanwhile, one surface of the blade portion 113 and one surface of the head portion 171, on which the insertion fixing portion 172 is formed, has a stepped portion a formed by a preset interval (see FIG. 3).

In case that the blade portion 113 is in direct contact with the vehicle (not illustrated) when the pedal simulator 100 is installed in the vehicle (not illustrated), a load, which is applied during the installation process, is transmitted to the blade portion 113, which may cause a concern that the blade portion 113 is damaged.

However, because the stepped portion a is provided as described above, it is possible to prevent the blade portion 113 from being in direct contact with the vehicle (not illustrated) and prevent a load, which is applied during the installation process, from being transmitted to the blade portion 113. In addition, as described above, the protrusions 171a may be formed on the head portion 171 to reduce the contact area between the head portion 171 and the blade portion 113, thereby reducing friction and the transmission of the load between the fastening member 170 and the blade portion 113.

The piston 120 is inserted into one side of the cylinder body 110 so as to be movable forward and rearward by an operation of a pedal. However, the piston is inserted into the guide bushing 130 inserted into one side of the cylinder body 110 without being in direct contact with the cylinder body 110.

The piston 120 includes a piston body 121, and a cross-section of the piston body 121, which intersects the longitudinal direction, has a circular or polygonal column shape. In the present embodiment, the piston body 121 is formed in a cylindrical shape. The other side of the piston 120 comes into contact with the damper 130 when the piston 120 moves forward. A damper insertion groove 123 is formed at the other side of the piston body 121 and has a shape identical to a shape of the damper 125. Therefore, when the piston 120 moves forward, one side of the damper 125 is inserted into the damper insertion groove 123.

The piston 120 includes a piston flange 122 protruding from an outer peripheral surface of the piston body 121 disposed at a position spaced apart from the other side of the piston body 121 by a preset distance toward one side of the piston body 121. The piston flange 122 extends in a circumferential direction of the piston body 121. The piston flange 122 prevents the piston 120 from being withdrawn to the outside from the guide bushing 130.

A stopper member 190 is provided between the piston flange 122 and the guide bushing 130. The stopper member 190 absorbs an impact and prevents noise when the impact and noise are generated by the forward and rearward movements of the piston 120. The stopper member 190 will be described below in more detail.

The damper 125 is provided in the cylinder body 110. The damper 125 transfers pedal feel to an electric booster (not illustrated) through a pressure applied from the piston 120.

When the piston 120 moves forward as described above, the piston 120 comes into contact with the damper 125 and applies a pressure to the damper 125. Further, the damper 125 transfers the pedal feel to the electric booster (not illustrated) through the applied pressure. An electronic brake (not illustrated) is equipped with a pressure sensor (not illustrated), and the pressure sensor (not illustrated) measures the pressure applied to the damper 125.

In addition, it is possible to determine whether the damper 125 is damaged or broken on the basis of a value of the pressure applied by the damper 125 and measured by the pressure sensor (not illustrated). For example, a pressure equal to or higher than a preset value needs to be measured from the damper 125. However, the pressure equal to or higher than the preset value is not measured, it is possible to determine that the damper 125 is damaged or broken.

Meanwhile, although not illustrated in the drawings, the damper 125 may be equipped with a force sensor. The force sensor (not illustrated) identifies whether the damper 125 is damaged on the basis of the pressure applied to the damper 125.

The guide bushing 130 is inserted into one side of the cylinder body 110. The guide bushing 130 is provided to reduce friction between the cylinder body 110 and the piston 120.

The guide bushing 130 includes a bushing body 131 having a hollow portion 131a formed in the longitudinal direction so that the piston 120 is penetratively inserted into the guide bushing 130. The bushing body 131 is made of a plastic material. The guide bushing 130 may store a lubricant to reduce friction between the guide bushing 130 and the piston 120.

The guide bushing 130 includes a lubricant flow path 132 formed in an inner peripheral surface of the bushing body 131 and configured to store the lubricant. The lubricant flow path 132 is formed to be concave by a preset length in the longitudinal direction of the bushing body 131 from a position spaced apart from the other side of the bushing body 131 by a preset distance toward one side of the bushing body 131.

The guide bushing 130 includes a bushing flange 133. The bushing flange 133 is formed on an outer peripheral surface of the bushing body 131. Specifically, the bushing flange protrudes from an outer peripheral surface of the bushing body 131 disposed at a position spaced apart from one side of the bushing body 131 by a preset distance toward the other side of the bushing body 131. The bushing flange extends in a circumferential direction of the bushing body 131. Therefore, when the guide bushing 130 inserted into the cylinder body 110, the cylinder body 110 is caught by the bushing flange 133.

The bushing flange 133 has a boot coupling groove 133a, and the boot coupling groove 133a is concavely formed in an outer peripheral surface of the bushing flange 133 and extends in a circumferential direction of the bushing flange 133. One side of the boot 152, which is one of the components of the return means 150, is fitted with and coupled to the boot coupling groove 133a.

Meanwhile, the guide bushing 130 further includes a sealing coupling groove 134. The sealing coupling groove 134 is formed in the outer peripheral surface of the bushing body 131. Specifically, the sealing coupling groove is concavely formed in an outer peripheral surface of the bushing body 131 disposed at a position spaced apart from the other side of the bushing body 131 by a preset distance toward one side of the bushing body 131, and the sealing coupling groove extends in a circumferential direction of the bushing body 131.

A sealing member s is provided in the sealing coupling groove 134 and maintains sealability between the cylinder body 110 and the guide bushing 130.

When the guide bushing 130 is inserted into one side of the cylinder body 110, one end of the cylinder body 110 is fitted into a fixing groove (not illustrated) formed in the bushing flange 133. Although not illustrated in the drawings in detail, the fixing groove (not illustrated) is formed in one surface of the bushing flange 133, which is in contact with one end of the cylinder body 110. The fixing groove is formed concavely and extends in the circumferential direction of the bushing body 131.

A width of the fixing groove (not illustrated) is equal to a thickness of one end of the cylinder body 110. The cylinder body 110 may be fixed to the guide bushing 130 when an operator compresses one side of the cylinder body 110 by using a clamping member (not illustrated) and fitting one side of the cylinder body 110 into the fixing groove (not illustrated).

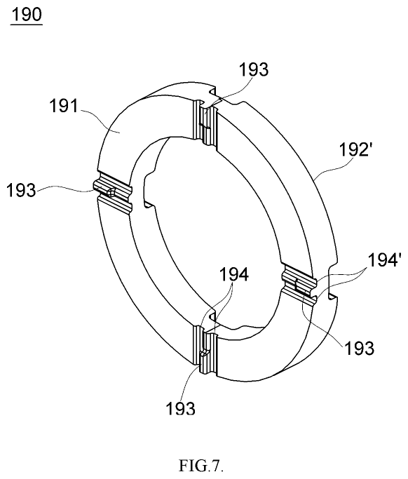

The stopper member 190 is provided between the piston 120 and the guide bushing 130. FIG. 7 illustrates the stopper member 190. The stopper member 190 is formed in a ring shape. The stopper member is provided so that one surface 191 thereof is directed toward the guide bushing 130, and the other surface 192 is directed toward the piston flange 122 of the piston 120.

Protrusions 193 are formed on one surface 191. That is, the protrusions 193 are in contact with the guide bushing 130. The protrusions 193 are provided as a plurality of protrusions 193 formed on one surface 191 and spaced apart from one another by a preset angle in a circumferential direction of the stopper member 190. The protrusions 193 are formed on the stopper member 190, which may reduce a contact area between the stopper member and the guide bushing 130 and reduce noise that occur when the piston 120 is separated from the guide bushing 130 when the piston 120 moves forward.

Concave grooves 194 are formed in one surface 191 and provided at two opposite sides based on the protrusion 193. The groove 194 serves as an avoidance space so that the portions having the protrusions 193 may be easily deformed so the piston 120 and the protrusions 193 come into contact with one another first and then the piston 120 is tightly attached to one surface 191. Because the stopper member 190 is made of a material having an elastic force and the groove 194 is formed, which further increases a close-contact force between the other surface 192 and the piston flange 122 when a pressure is applied. Like the protrusions 193, the grooves 194 are provided as a plurality of grooves 194 spaced apart from one another by a preset angle in the circumferential direction of the stopper member 190.

The stopper member 190 serves to reduce noise as described above and also serves to absorb an impact when the impact occurs when the piston 120 moves forward and rearward.

When the piston 120 moves rearward, outside air is introduced into the cylinder body 110, passes through a vent flow path 135, and is introduced into the boot 152. The filter member 180 is provided at the other side of the piston 120 to remove foreign substances from the air when the outside air is introduced into the cylinder body 110.

The filter member 180 includes a filter 181 and a filter fixing cover 182. The filter 181 is disposed forward of the damper coupling portion 112. The filter removes foreign substances in outside air while the outside air passes through the filter 181.

The filter fixing cover 182 is disposed forward of the filter 181 and provided at a position opposite to the damper coupling portion 112 based on the filter 181. The filter fixing cover 182 is coupled to the cylinder body 110 and prevents the filter 181 from being withdrawn from the cylinder body 110.

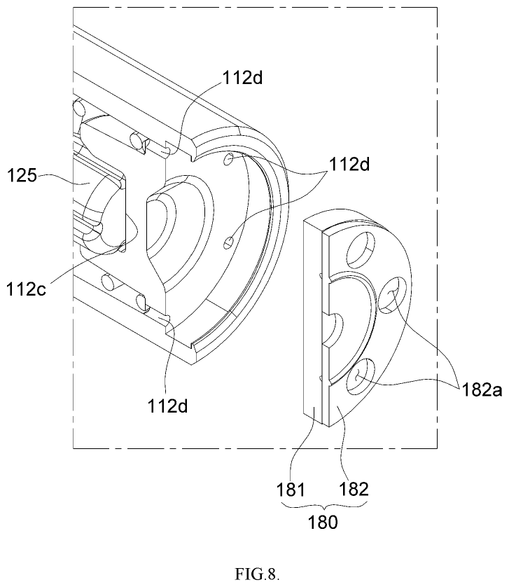

With reference to FIG. 8, cover holes 182a are formed in the filter fixing cover 182. The cover holes 182a are provided as a plurality of cover holes 182a spaced apart from one another at a preset angle in the circumferential direction of the filter fixing cover 182. Outside air is introduced through the cover holes 182a and passes through the filter 181.

In the related art, because a pedal simulator is integrated with an electric booster (not illustrated), the pedal simulator may be connected to a pedal when the electric booster is coupled to a firewall in a vehicle. In particular, in this case, there is a problem in that the pedal needs to be a pedal, which defines a circular trajectory downward, so as to be connected to the pedal simulator, a space in an engine room needs to be ensured, and a plurality of (two) assembling operators is required. That is, it is difficult to apply the pedal simulator to an organ type pedal.

The pedal simulator according to the present embodiment is separated from the electric booster, such that the pedal simulator may be connected to even an organ type pedal. The organ type pedal is a pedal that defines a circular trajectory upward. The pedal simulator 100 according to the present embodiment has a degree of installation freedom, such that the pedal simulator 100 may be disposed and assembled to be inclined downward by a preset angle with respect to an imaginary horizontal line passing through an axis along which the organ type pedal (not illustrated) and the pedal simulator 100 are connected.

The organ-type pedal (not illustrated) may be installed by a single operator, which may improve assembling conditions.

While the embodiments of the present disclosure have been described with reference to the accompanying drawings, those skilled in the art will understand that the present disclosure may be carried out in any other specific form without changing the technical spirit or an essential feature thereof.

Accordingly, it should be understood that the aforementioned embodiments are described for illustration in all aspects and is not limited, and the scope of the present disclosure shall be represented by the claims to be described below, and it should be construed that all of the changes or modified forms induced from the meaning and the scope of the claims, and an equivalent concept thereto are included in the scope of the present disclosure.

1. A pedal simulator comprising:
a cylinder body having a groove so that one side thereof is opened, and the other side thereof is closed;
a piston inserted in one side of the cylinder body and configured to be movable forward and rearward in conjunction with an operation of a pedal;
a guide bushing provided at one side of the cylinder body and configured to reduce friction between the cylinder body and the piston;
a damper provided in the cylinder body and configured to transfer pedal feel to an electric booster by means of a pressure applied from the piston;
a push rod having one side connected to the pedal, and the other side connected to the piston, the push rod being configured to move the piston forward toward the damper in conjunction with the operation of the pedal; and
a return means provided while covering one side of the guide bushing and a part of the push rod and configured to provide a restoring force for moving rearward the push rod that has moved forward.

2. The pedal simulator of claim 1, wherein the cylinder body comprises a damper coupling portion protruding from a position spaced apart from the other side of the cylinder body by a preset distance toward one side of the cylinder body, the damper coupling portion being formed so that the damper is coupled to the damper coupling portion.

3. The pedal simulator of claim 2, wherein the damper coupling portion comprises a damper coupling groove formed concavely in one surface thereof so that the damper is inserted and coupled into the damper coupling groove.

4. The pedal simulator of claim 3, wherein the damper coupling portion further comprises one or more vent holes formed through the damper coupling portion in a direction parallel to a longitudinal direction of the cylinder body so that air in the cylinder body is discharged to the outside or outside air is introduced into the cylinder body.

5. The pedal simulator of claim 1, wherein the cylinder body further comprises blade portions extending from an outer peripheral surface of the cylinder body in a direction intersecting a longitudinal direction of the cylinder body, and wherein the blade portions are provided as a pair of blade portions formed to be symmetric based on a central axis that penetrates the cylinder body in the longitudinal direction of the cylinder body.

6. The pedal simulator of claim 5, wherein a through-hole is formed in the blade portion in a direction parallel to the longitudinal direction of the cylinder body.

7. The pedal simulator of claim 6, further comprising:
a fastening member configured to penetrate the through-hole and coupled to the cylinder body, the fastening member being configured to fix the cylinder body to a vehicle.

8. The pedal simulator of claim 1, wherein the guide bushing comprises a bushing body having a hollow portion formed in a longitudinal direction so that the piston is penetratively inserted in the hollow portion.

9. The pedal simulator of claim 8, wherein the guide bushing comprises a lubricant flow path formed concavely in an inner peripheral surface of the bushing body by a preset length in a longitudinal direction of the bushing body from a position spaced apart from the other side of the bushing body by a preset distance toward one side of the bushing body so that the lubricant flow path stores a lubricant.

10. The pedal simulator of claim 9, wherein the lubricant flow path is provided as a plurality of lubricant flow paths spaced apart from one another by a preset angle in a circumferential direction of the bushing body.

11. The pedal simulator of claim 10, wherein the guide bushing further comprises a bushing flange protruding from an outer peripheral surface of the bushing body at a position spaced apart from one side of the bushing body by a preset distance toward the other side of the bushing body, the bushing flange extending in a circumferential direction of the bushing body.

12. The pedal simulator of claim 9, wherein the return means comprises:
a first elastic member connected to one side of the guide bushing while covering the push rod and configured to move the push rod rearward by an elastic force; and
a boot coupled to one side of the guide bushing while covering the first elastic member and configured to be contracted and expanded by the forward and rearward movements of the piston.

13. The pedal simulator of claim 12, wherein the return means further comprises a second elastic member configured to cover the damper and having one side connected to the damper coupling portion, and the other side connected to the piston, the second elastic member being provided in the cylinder body and configured to move the piston rearward by an elastic force.

14. The pedal simulator of claim 12, wherein the guide bushing further comprises a vent flow path provided to allow air to flow in accordance with a change in volume of an interior of the cylinder body and a change in volume of the boot by the forward and rearward movements of the piston.

15. The pedal simulator of claim 14, wherein the vent flow path is formed concavely in an inner peripheral surface of the bushing body in a longitudinal direction, and the vent flow path is provided as a plurality of vent flow paths spaced apart from one another by a preset angle in a circumferential direction of the bushing body.

16. The pedal simulator of claim 15, wherein the vent flow path is formed between the adjacent lubricant flow paths.

17. The pedal simulator of claim 2, further comprising:
a filter member provided at the other side of the cylinder body and configured to remove foreign substances in air introduced into the cylinder body from the outside.

18. The pedal simulator of claim 17, wherein the filter member comprises:
a filter disposed forward of the damper coupling portion; and
a filter fixing cover coupled to the cylinder body and disposed at a position opposite to the damper coupling portion to prevent the filter from being withdrawn.

19. The pedal simulator of claim 1, wherein the piston comprises a piston flange protruding from an outer peripheral surface at a position spaced apart from the other side by a preset distance toward one side, the piston flange extending in a circumferential direction of the piston.

20. The pedal simulator of claim 19, further comprising:
a stopper member provided between the piston flange and the guide bushing and configured to absorb an impact and prevent noise when the impact and noise are generated by the forward and rearward movements of the piston.
